(19) United States
(12) Patent Application Publication
(10) Pub. No.: US 2026/0150073 A1
(43) Pub. Date: May 28, 2026

(54) FIRST NODE AND METHODS PERFORMED THEREBY FOR HANDLING LOCATION OF A NETWORK NODE IN A GEOGRAPHICAL AREA FOR OPERATION IN A COMMUNICATIONS SYSTEM

(71) Applicant: Telefonaktiebolaget LM Ericsson (publ), Stockholm (SE)

(72) Inventors: Satish Kumar KOLLI, Hyderabad (IN); Sumit SOMAN, Noida (IN)

(21) Appl. No.: 19/119,894

(22) PCT Filed: Oct. 12, 2022
(86) PCT No.: PCT/IN2022/050911

§ 371 Date: Apr. 10, 2025

(51) Int. Cl. H04W 64/00; H04W 4/021; H04W 28/08

(52) U.S. Cl. CPC H04W 64/00; H04W 4/021; H04W 28/0967

(57) ABSTRACT

A computer-implemented method, performed by a first node, for handling location of a network node in a geographical area for operation in a communications system. The first node obtains first data indicating images of the geographical area over a first time period. The first node also obtains second data indicating data samples of performance indicators of radio communications, during the first time period, of devices in the geographical area. The first node determines, by performing a spatio-temporal correlation of the obtained first data and the obtained second data, one or more locations as candidates to place the network node for operation in the communications system. The determining is performed using machine learning or deep learning, and. The first node then outputs an indication of the determined one or more locations.

### TECHNICAL FIELD

The present disclosure relates generally to a first node and methods performed thereby, for handling location of a network node in a geographical area for operation in a communications system. The present disclosure also relates generally to a computer programs and computer-readable storage mediums, having stored thereon the computer programs to carry out these methods.

### BACKGROUND

Computer systems in a communications system or network may comprise one or more nodes, which may also be referred to simply as nodes. A node may comprise one or more processors which, together with computer program code may perform different functions and actions, a memory, a receiving port and a sending port. A node may be, for example, a server. Nodes may perform their functions entirely on the cloud.

Radio Frequency (RF) Design may be understood to be performed to simulate a network and determine what may be the best configuration. This may be done for multiple purposes, which may include improvement of existing network performance parameters at a site, or for planning installation at a new site. The performance of a communications network may be measured by the analysis of data indicating its performance, such as, for example, Key Performance Indicators (KPIs).

Network design may be understood to consider the physical properties of a site such as location, height, azimuth, antenna, as well as network parameters and settings to meet various KPI targets. It may be understood that network parameters may refer to clutter, terrain, network traffic, propagation models, as well as other settings which may be available in planning tools. The KPI targets may understood to be often set by the customers.

The network, or RF Design may be understood to significantly determine the performance of the network. During tuning or optimization of the parameters, several parameters may be modified, however the KPI targets may improve significantly only if the physical properties of the site are optimal. Thus, it may be understood that to be important to have a good design before the subsequent phases of network rollout.

The simulation of the radio network may be understood to be performed by the use of planning tools that may be used to identify or predict candidate, good and problem, areas for the respective use-cases.

The typical RF Design, or site survey workflow, is schematically shown in FIG. 1. The boxes thicker lines may be typically executed by a Site Acquisition (SA) team, while the others may be typically executed by an RF Design team. At 1, the RF designers may initially come up with a preliminary radio network design, which may be understood to involve the identification of one or more preliminary location(s) based on available or existing information. At 2, the SA team may then identify a search order and radius around the identified preliminary location(s) and may then at 3 conduct a physical site survey to collect information and at 4 generate the reports for the candidate sites. The reports may be ranked by the SA team at 5, and this may optionally involve conducting drive tests around one or more candidate locations to refine or update the reports to yield a final design at 6.

Site survey may be understood to be the most important step of network deployment. The main idea of doing this survey may be understood to be to convert a nominal plan, that is, an initial design, into a physical location. Once this step is through, the network may be in line with the design. This may help the optimization engineers to manage the KPIs within the Service Level Agreements (SLA). The RF site survey may thus be meant to find a location that may be suitable to meet radio network design requirements in terms of coverage and capacity.

Based on the ranked site reports generated by the SA team, the RF design team may proceed to develop the final network design before deployment or execution. It may be understood here that conducing site surveys is an expensive, and/or effort-intensive task which involves cost and is not automated.

Tools may be developed to facilitate the site survey process by introducing automation to reduce or complement the physical effort of conducting the survey. The planning tools that may be used in the RF Design process may require to estimate the locations of existing cellular towers. It may thus be understood that cell tower selection for network planning and design may involve estimation of the location, latitude and longitude, of sites, existing and new. A complete source of truth, that is, the accurate or exact locations of all cellular towers and associated cells, in a region, may often be unavailable due to diverse geographies, operators, communication technologies, or regulatory bodies.

Furthermore, existing methods for cell-tower estimation may be incomplete and/or have errors, leading to suboptimal placement of network nodes, and having as a consequence sub-optimal performance of a communications network.

### SUMMARY

As part of the development of embodiments herein, one or more challenges with the existing technology will first be identified and discussed.

Existing approaches for cell-tower estimation may be based on Crowd-Sourced (CS) data. CS data may be understood as data, including e.g., network performance parameters, generated by tests initiated from User Equipments (UEs) through a participatory approach, which may involve a large number of users. CS data may be used to estimate cell tower locations as they may include User Equipment (UE) locations and timestamps, along with cell identifiers and signal strength attributes. Such estimations derived from CS data may have error due to the density and quality of available CS data samples. Density may be understood to refer to the number of samples, or measurement reports, available in a given geographical area. This may differ due to various factors which may include the area being rural or urban, number of radio network operators available, network technologies supported, number of active users, among others. Further, quality may be understood to be the accuracy of the measurement report which may include measurements of signal strength such as Cell Quality Index (CQI), Reference Signal Received Power (RSRP), Reference Signal Received Quality (RSRQ), Received Signal Strength Indicator (RSSI), Signal to Interference Noise Ratio (SINR) among others. This may be inaccurate due to issues such as a user being non-line-of-sight, physical or geographical terrain, user movement and handover, among others. These factors may introduce errors in estimations derived from CS data.

Existing approaches using Computer Vision (CV) methods have also used deep networks for utility pole detection from street view image datasets. However, this may have false positives and it is not correlated with telecommunications or network data. These methods may provide locations of potential poles as input to the site survey process. These may also involve estimation of pole parameters such as height, tilt or other constructability parameters. However, existing methods do not leverage any relation with telecommunications or network data.

It is an object of embodiments herein to improve the handling location of a network node in a geographical area for operation in a communications system.

According to a first aspect of embodiments herein, the object is achieved by a computer-implemented method performed by a first node. The method is for handling the location of the network node in the geographical area for operation in the communications system. The first node obtains first data. The first data indicates images of the geographical area over a first time period. The first node also obtains second data. The second data indicates data samples of performance indicators of radio communications, during the first time period, of devices in the in the geographical area. The first node then determines, by performing a spatio-temporal correlation of the obtained first data and the obtained second data, one or more locations as candidates to place the network node for operation in the communications system. The determining is performed using machine learning or deep learning. The first node then outputs an indication of the determined one or more locations.

According to a second aspect of embodiments herein, the object is achieved by the first node. The first node is for handling the location of the network node in the geographical area for operation in the communications system. The first node is configured to obtain the first data. The first data is configured to indicate the images of the geographical area over the first time period. The first node is further configured to obtain the second data. The second data is configured to indicate the data samples of the performance indicators of radio communications, during the first time period, of the devices in the geographical area. The first node is also configured to determine, by performing the spatio-temporal correlation of the first data and the second data configured to be obtained, the one or more locations as candidates to place the network node for operation in the communications system. The determining is configured to be performed using the machine learning or deep learning. The first node is additionally configured to output the indication of the one or more locations configured to be determined.

According to a third aspect of embodiments herein, the object is achieved by a computer program, comprising instructions which, when executed on at least one processing circuitry, cause the at least one processing circuitry to carry out the method performed by the first node.

According to a fourth aspect of embodiments herein, the object is achieved by a computer-readable storage medium, having stored thereon the computer program, comprising instructions which, when executed on at least one processing circuitry, cause the at least one processing circuitry to carry out the method performed by the first node.

By the first node determining the one or more locations by performing the spatio-temporal correlation of the first data and the second data, the first node may enable to ensure that the outputs generated by the processing pipeline using both the first data and the second data to generate inputs for e.g., user interfaces of a network planning tool, may be spatio-temporally correlated, and thus may result in improved accuracy estimation by the first node.

Embodiments herein may be employed either to largely replace, or augment, the existing site surveying process. The inputs that may be required by the site acquisition team may be largely generated by the estimated tower locations, network parameters or KPIs and utility pole locations generated according to embodiments herein. This may be understood to significantly lower the costs of performing the survey and result in societal energy benefits, while also providing an automated pipeline for processing incoming data and updating candidate locations that may be recommended by the approach described herein. From a broader perspective, this may enable to improve and streamline the RF, or network, design workflow for various network planning and design use-cases. It may also enable the generation of a ranking or recommendation of potential sites and network parameters from the planning tools for use by the design team.

The described approach may introduce a scalable automation in the network design and planning pipeline.

The approach followed by embodiments herein may enable to pro-actively identify areas for improving network coverage and capacity. Coverage holes or capacity issues may be identified or detected with second e.g., CS, data, which may be useful input for the network planning and design workflow.

By the first node outputting the indication, the first node may enable that it may be consumed by, e.g., user interfaces in network planning tools. Thia may enable to enhance the ability of the planning tools to provide new sites for capacity or coverage expansion that may incorporate geo-spatial and network parameters.

Embodiments herein may advantageously reduce, or alleviate the efforts for manual surveying, improve design lead times, improve quality of candidate selection and reduce Capital expenditures (CAPEX) significantly.

Furthermore, embodiments herein may advantageously assist the network planning & design teams in potential candidate selection of cell towers, e.g., using CS and CV, for new installations.

Another advantage of embodiments herein may be understood to be that they may enable to improve the network. This may be understood to be because embodiments herein may also be used to re-locate the existing site locations to new locations if the benefit may be high, for example, if the CS data may indicate that network KPIs may be better for a candidate site. This may, additionally, result in lower CAPEX compared to new site installation.

Yet another advantage of embodiments herein may be understood to be to enable an eventual improvement in customer experience in terms of coverage and capacity.

### BRIEF DESCRIPTION OF THE DRAWINGS

Examples of embodiments herein are described in more detail with reference to the accompanying drawings, and according to the following description.

FIG. 1 is a schematic diagram illustrating a conventional RF design/site survey workflow.

FIG. 2 is a schematic diagram illustrating two non-limiting embodiments, in panel a) and panel b) a communications system, according to embodiments herein.

FIG. 3 is a flowchart depicting a method in a first node, according to embodiments herein.

FIG. 4 is a flowchart depicting aspects of a non-limiting example of a method in a first node, according to embodiments herein using CS data.

FIG. 5 is a flowchart depicting aspects of another non-limiting example of a method in a first node, according to embodiments herein, processing street view images.

FIG. 6 is a flowchart depicting a further non-limiting example of a method in a first node, according to embodiments herein, combining the CS-based approach with the CV approach.

FIG. 7 is a schematic diagram illustrating another non-limiting example of some aspects of the method performed in the communications system, according to embodiments herein, with details in the network planning workflow.

FIG. 8 is an illustration of a non-limiting example of cell coverage polygons generated using multiple crowdsourced datasets, according to embodiments herein.

FIG. 9 is a schematic diagram illustrating a further non-limiting example of some aspects of the method performed in the communications system, according to embodiments herein.

FIG. 10 is a schematic block diagram illustrating a non-limiting example of a first node, according to embodiments herein.

### DETAILED DESCRIPTION

Certain aspects of the present disclosure and their embodiments may provide solutions to the challenges discussed in the Background and Summary sections. There are, proposed herein, various embodiments which address one or more of the issues disclosed herein.

As a summarized overview, embodiments herein may be understood to relate to a method and system for integrating utility pole detection and crowdsourced data for cell tower location. Embodiments herein may efficiently leverage CS data and image data into a scalable pipeline that may exploit their spatio-temporal correlation for cell tower location use-cases, and that may incorporate such correlation between static images and dynamic network performance measurement parameters for the network planning and design use-cases.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from Long Term Evolution (LTE)/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

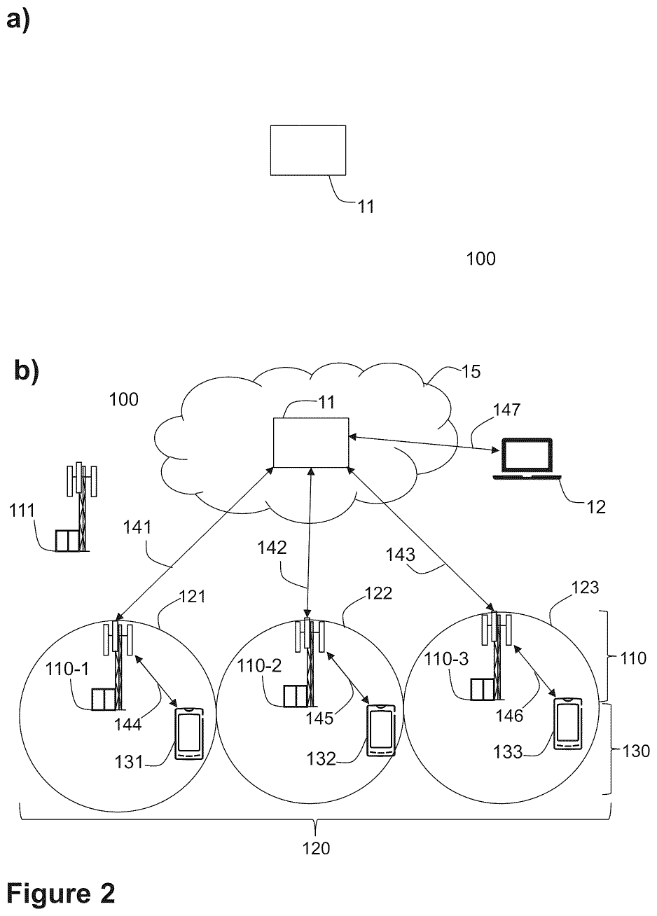

FIG. 2 depicts two non-limiting examples, in panels “a” and “b”, respectively, of a communications system 100, in which embodiments herein may be implemented. In some example implementations, such as that depicted in the non-limiting example of FIG. 2a, the communications system 100 may be a computer system. In other example implementations, such as that depicted in the non-limiting example of FIG. 2b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as a 5G system, e.g., 5G Core Network (CN), 5G New Radio (NR), an Internet of Things (IoT) network, an LTE network, e.g. LTE Frequency Division Duplex (FDD), LTE Time Division Duplex (TDD), LTE Half-Duplex Frequency Division Duplex (HD-FDD), LTE operating in an unlicensed band, or a newer system supporting similar functionality. The telecommunications system may also support other technologies, such as, e.g., Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 comprises a first node 11, which is depicted in FIG. 2. In some examples, such as that depicted in panel b) of FIG. 2, the communications system 100 may comprise a second node 12. The first node 11 may be understood as a first computer system and the second node 12 may be understood as a second computer system. In some examples, any of the first node 11 and the second node 12 may be implemented as a standalone server in e.g., a host computer in the cloud 15, as depicted in the non-limiting example depicted in panel b) of FIG. 2 for the first node 11. Any of the first node 11 and the second node 12 may, in some examples, be a distributed node or distributed server, with some of their respective functions being implemented locally, e.g., by a client manager, and some of their respective functions implemented in the cloud 15, by e.g., a server manager. Yet in other examples, any of the first node 11 and the second node 12 may also be implemented as processing resources in a server farm. Any of the first node 11 and the second node 12 may, in some examples, be a core network node. In other examples, any of the first node 11 and the second node 12 may be a radio network node.

The first node 11 may be understood as to be a node having a capability to train one or more predictive models using ML.

The second node 12 may be e.g., a user interface of a network planning tool.

The communication system 100 also comprises existing network nodes 110, that is, network nodes that are already deployed in the communications system 100. Herein a pole, utility pole or tower may also be understood to refer to one of the existing network nodes 110. In the non-limiting example of panel b) in FIG. 2, the communications system 100 is depicted comprising a first existing network node 110-1, a second existing network node 110-2 and a third existing network node 110-3. A network node 111, that is, a further network node or a new network node, may have to be located, e.g., deployed, in the communications system 100. Any of the existing network nodes 110 and the network node 111 may be understood to be a radio network node, as depicted in panel b) of FIG. 2. Any of the existing network nodes 110 and the network node 111 may typically be a base station or Transmission Point (TP), or any other network unit capable to serve a wireless device or a machine type node in the communications system 100. The radio network node may be e.g., a 5G gNB, a 4G eNB, or a radio network node in an alternative radio access technology, e.g., fixed or WiFi. Any of the existing network nodes 110 and the network node 111 may be e.g., a Wide Area Base Station, Medium Range Base Station, Local Area Base Station and Home Base Station, based on transmission power and thereby also coverage size. Any of the existing network nodes 110 and the network node 111 may be a stationary relay node or a mobile relay node. Any of the existing network nodes 110 and the network node 111 may support one or several communication technologies, and its name may depend on the technology and terminology used. Any of the existing network nodes 110 and the network node 111 may be directly connected to one or more networks and/or one or more core networks.

The first node 11 may be a separate node from any of the existing network nodes 110. In some embodiments, the first node 11 may be co-localized or be the same node as any of the existing nodes 100. All the possible combinations are not depicted in FIG. 2 to simplify the Figure.

The communications system 100 may cover a geographical area, which in some embodiments may be divided into cell areas, wherein each cell area may be served by a radio network node, although, one radio network node may serve one or several cells. The existing network nodes 110 serve existing cells 120. In the non-limiting example of FIG. 2, the first existing node 110-1 serves a first cell 121, the second existing node 110-2 serves a second cell 122 and the third existing node 110-3 serves a third cell 123. It may be understood to that the communications system may comprise more existing nodes 110 than those depicted in FIG. 2 b), as well as further existing cells 120. The number of existing network nodes 110 and existing cells 120 in FIG. 2 may be understood to be non-limiting and for illustrative purposes only. Any of the existing network nodes 110 and the network node 111 may be of different classes, such as, e.g., macro eNodeB, home eNodeB or pico base station, based on transmission power and thereby also cell size. In some examples, any of the existing network nodes 110 and the network node 111 may serve receiving nodes with serving beams. Any of the existing network nodes 110 and the network node 111 may support one or several communication technologies, and its name may depend on the technology and terminology used. Any of the existing network nodes 110 that may be comprised in the communications system 100 may be directly connected to one or more core networks.

The communications system 100 may comprise devices 130 in the geographical area, whereof a first device 131, a second device 132 and a third device 133 are depicted in panel b) of FIG. 2 for illustrative purposes. In the non-limiting particular example of panel b) in FIG. 2, the first device 131 is served by the first existing network node 110-1, the second device 132 is served by the second existing network node 110-2, and the third device 133 device is served by the third existing network node 110-3. It may be understood that each of the existing network nodes 110 may respectively serve one or more devices. Only one device is depicted as being served by each of the existing network nodes 110 in panel b) of FIG. 2 to simplify the figure. Any of the existing devices 130 in the communications system 100 may be also known as e.g., user equipment (UE), a wireless device, mobile terminal, wireless terminal and/or mobile station, mobile telephone, cellular telephone, laptop with wireless capability, a Customer Premises Equipment (CPE), an Internet of Things (IoT) device, or a sensor, just to mention some further examples. Any of the existing devices 130 in the communications system 100 in the present context may be, for example, portable, pocket-storable, hand-held, computer-comprised, or a vehicle-mounted mobile device, enabled to communicate voice and/or data, via a RAN, with another entity, such as a server, a laptop, a sensor, an IoT device, a Personal Digital Assistant (PDA), or a tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. Any of the existing devices 130 in the communications system 100 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The first node 11 may communicate with the existing nodes 110, respectively, over a link. In the non-limiting example depicted in panel b) of FIG. 2, the first node 11 may communicate with the first existing network node 110-1 over a first link 141, e.g., a radio link or a wired link. The first node 11 may communicate with the second existing network node 110-2 over a second link 142, e.g., a radio link or a wired link. The first node 11 may communicate with the third existing network node 110-3 over a third link 143, e.g., a radio link or a wired link. The first existing network node 110-1 may communicate with the first device 131 over a fourth link 144, e.g., a radio link. The second existing network node 110-2 may communicate with the second device 132 over a fifth link 145, e.g., a radio link. The third existing network node 110-3 may communicate with the third device 133 over a sixth link 146, e.g., a radio link. The first node 11 may communicate with the second node 12 over a seventh link 147, e.g., a radio link or a wired link. Any of the first link 141, the second link 142, the third link 143 and/or the seventh link 147 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 2.

In general, the usage of “first”, “second”, “third”, “fourth”, “fifth”, “sixth” and/or “seventh” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

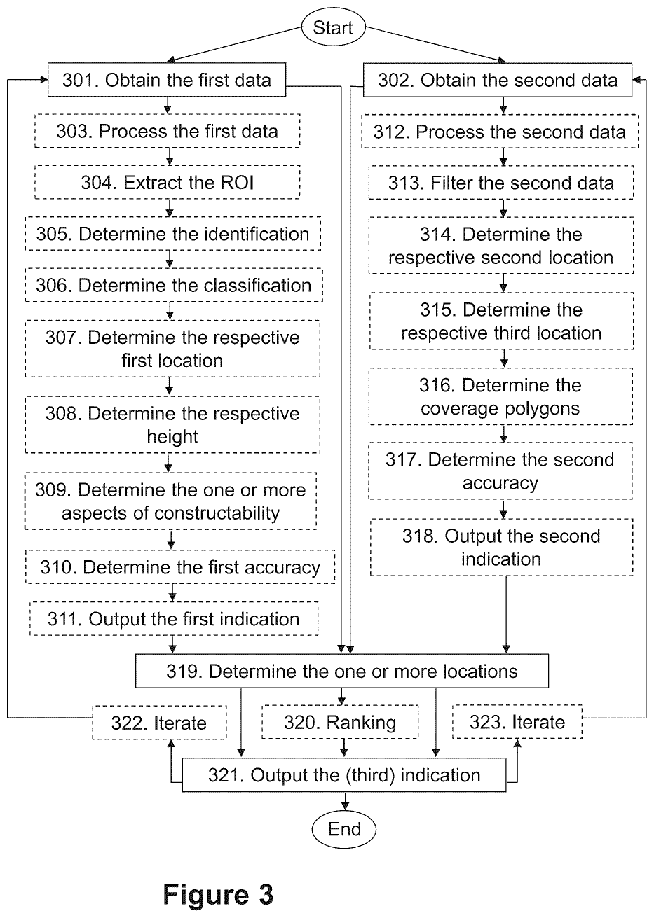

Embodiments of a computer-implemented method, performed by the first node 11, will now be described with reference to the flowchart depicted in FIG. 3. The method may be understood to be for handling deployment of the network node 111 in a geographical area for operation in the communications system 100. The first node 11 may be operating in the communications system 100.

The communications system 100 may, in some embodiments, be a Fifth Generation (5G) system.

The method may comprise the actions described below. In some embodiments some of the actions may be performed. In some embodiments, all the actions may be performed. In FIG. 3, optional actions are indicated with dashed boxes. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

### Action 301

The ultimate task at hand of embodiments herein may be understood to be to estimate the ideal location, e.g., comprising latitude and longitude, of a new planned site based on performance indicators of radio communications such as KPIs, e.g., RSRP or SINR, or may involve upgradation of the site to meet network targets of the performance indicators of radio communications. In either cases, this may involve determination, and optionally ranking, of potential candidate locations and the existing network performance parameters.

In order to ultimately estimate the potential candidate locations, in this Action 301, the first node 11 obtains first data. The first data indicates images of the geographical area over a first time period. The first time period may be, for example, a few weeks, a few months, etc.

The geographical area may comprise an extension of e.g., square meters, square kilometres, etc . . .

Obtaining may be understood as receiving, or retrieving. In some examples, the obtaining may be, e.g., from one or more digital image acquisition devices by users, as captured by the devices, and/or from entities involved in providing images of such nature.

In some examples, the receiving may be e.g., via the first link 141, the second link 142 and/or the third link 143, from the devices 130 in the geographical area.

The images may be street-view images, drone images or digital images.

The first data may be streams or batches of incoming street view images.

By obtaining the first data in this Action 301, the first node 11 may be enabled to estimate the location of the existing network nodes 110, and ultimately the potential candidate locations of the network node 111, as will be described in the next actions.

### Action 302

In this Action 302, the first node 11 obtains second data. The second data indicates data samples of performance indicators of radio communications, during the first time period, of the devices 130 in the in the geographical area.

The performance indicators may be, e.g., KPIs, such as RSRP or SINR.

The second data may be crowdsourced (CS) data. The second data may be streams or batches of incoming CS data.

Obtaining may be understood as receiving, or retrieving e.g., via the first link 141, the second link 142 and/or the third link 143, from the devices 130 in the geographical area, via the existing network nodes 110 which may be respectively serving them.

By obtaining the second data in this Action 302, the first node 11 may be enabled to estimate the location of the existing network nodes 110 and the existing cells 120 as well as the cell coverage polygons, and ultimately the potential candidate locations of the network node 111, as will be described in the next actions.

### Action 303

In this Action 303, the first node 11 may process the obtained first data for subsequent analysis. To process may be comprise that the obtained images may be pre-processed for cleaning, noise-removal or other quality criteria. For example, the first data may be obtained in different formats, different granularity, etc.

The processing in this Action 303 may be performed by one or more image processing techniques.

By processing the obtained first data in this Action 303, the first node 11 may be enabled to compile the collected first data for analysis, so that most of the collected first data may be used, and then use the data for further analysis with a higher level of accuracy.

### Action 304

In This Action 304, the first node 11 may extract a region of interest (ROI) from the processed first data.

The extracting in this Action 304 may be performed by a combination of one or more morphological image processing techniques or deep networks used in computer vision applications.

By extracting the ROI in this Action 304, the first node 11 may be enabled to then filter the first data in the next Action 305 and thereby reduce the amount of first data to be analyzed, out of the totality of first data that may have been collected, to simplify the computations to the region that may be of interest for the placement of the network node 111.

### Action 305

In this Action 305, the first node 11 may determine, using the processed first data, an identification of existing network nodes 110 in the extracted region of interest or geographical area.

Determining may be understood as calculating, deriving, or similar.

The determining in this Action 305 may be performed by object detection, e.g., deep learning, models used in computer vision applications.

In this Action 305, the first node 11 may estimate the respective bounding box of the existing network nodes 110, also referred to herein as the poles, in the images comprised in the extracted first data. The bounding box may be understood to refer to a rectangle or polygon coordinates that may enclose an image or object of interest in an image. They may be understood to be used to bind or identify a target and may serve as a reference point for object detection in images.

By the first node 11 determining the identification of the existing network nodes 110 in this Action 305, the first node 11 may be enabled to estimate their respective location.

### Action 306

In this Action 306, the first node 11 may determine, using the extracted first data, a classification of the existing network nodes 110 in the extracted region of interest or geographical area.

The classification may be with regards to e.g., type of network node, material etc. Types of network node may be understood to refer to the nature of a pole, such as for example utility poles, towers, existing cell towers such as monopole, lattice etc.

In some embodiments, the determining in this Action 306 of the classification may be performed using computer vision methods. Particularly, the determining in this Action 306 may be performed by object classification, e.g., deep learning, models used in computer vision applications.

By the first node 11 determining the classification of the existing network nodes 110 in this Action 306, the first node 11 may enable to select the relevant candidates for further processing to derive the locations in the next Action 307.

### Action 307

In this Action 307, the first node 11 may determine, using the extracted first data, a respective first location of the existing network nodes 110 in the extracted region of interest or geographical area.

Machine learning, or deep learning, models may be used to estimate, or predict, the pole location. In some embodiments, the determining in this Action 307 of the respective first location may be performed using computer vision methods.

By determining the respective first location of the existing network nodes 110 in this Action 307, the first node 11 may enable to ultimately derive the potential candidate locations of the network node 111.

### Action 308

In this Action 308, the first node 11 may determine, using the extracted first data, a respective height of the existing network nodes 110 in the extracted region of interest or geographical area.

The determining in this Action 308 may use machine learning, or deep learning. In some embodiments, the determining in this Action 308 of the respective height may be performed using computer vision methods. Particularly, the determining in this Action 308 may be performed using suitable machine learning or deep learning methods.

By determining the respective height of the existing network nodes 110 in this Action 308, the first node 11 may enable to ultimately derive the potential candidate locations of the network node 111. This may be by e.g., identifying coverage holes in the geographical area.

### Action 309

In this Action 309, the first node 11 may determine, using the extracted first data, one or more aspects of constructability in the extracted region of interest or geographical area.

The determining in this Action 309 may use machine learning, or deep learning. In some embodiments, the determining in this Action 309 of the one or more aspects of constructability may be performed using computer vision methods. Particularly, the determining in this Action 309 may be performed by using suitable machine learning or deep learning methods.

The one or more aspects of constructability may be understood to refer to aspects such as height at which new antennas may be installed, the number of antennas that may be placed, etc.

By determining the one or more aspects of constructability in this Action 309, the first node 11 may enable to determine aspects such as height at which new antennas may be installed, the number of antennas that may be placed, among others.

### Action 310

In this Action 310, the first node 11 may determine a respective first accuracy of the determined at least one of: the identification of existing network nodes 110, the classification of the existing network nodes 110, the respective first location of existing network nodes 110, the respective height of the existing network nodes 110 and the one or more aspects of constructability.

This Action 310 may be performed, for example, by an evaluator module managed by the first node 11.

The determining of the first accuracy in this Action 310 may be performed by evaluating metrics on the estimated locations when compared to the actual locations, e.g., of towers from a validation set. Such metrics may involve estimation of distance between the, e.g., latitude, longitude, of the estimated and actual location. Distances may be of multiple types, Euclidean, geodesic, Manhattan etc. The accuracy may be derived as one or more aggregated statistical measures of such distances for a set of estimated locations, e.g., mean, standard deviation etc.

### Action 311

In this Action 311, the first node 11 may output a respective first indication of the determined on the determined at least one of: identification, classification, respective first location, respective height, and one or more aspects.

The outputting in this Action 311 may be internal to the first node 11, e.g., to an evaluator module or engine managed by the first node 11, or to another node, e.g., to the second node 12.

In some embodiments, at least one of: the determining in Action 306 of the classification, the determining in Action 307 of the respective first location, the determining in Action 308 of the respective height, and the determining in Action 309 of the one or more aspects of constructability, may be performed using computer vision methods.

The first indication may for example indicate potential utility poles generated by the first node 11. However, at this stage, there may be understood to be no network performance data available to supplement the candidate sites.

### Action 312

In this Action 312, the first node 11 may process the obtained second data for subsequent analysis. This may be performed in a second stage of embodiments herein. The second stage may be performed subsequently to the Actions 303-311 or in parallel to them.

To process may be comprise that the obtained second data may be pre-processed for noise-removal or other quality criteria. For example, the second data may be obtained in different formats, different parameters, different granularity, etc . . .

The initial processing in this Action 312 of the available second data samples may involve ingestion, that is loading, of the samples from a storage medium to a processing medium, followed by pre-processing steps. The pre-processing steps may involve steps to address issues such as heterogeneous formats, granularity or parameters, which may be addressed by suitable methods for homogenization of formats, aggregation, or mapping of parameters, respectively.

By processing the obtained second data in this Action 312, the first node 11 may be enabled to compile the collected second data for analysis, so that most of the collected second data may be used, and then use the data for further analysis with a higher level of accuracy.

### Action 313

In this Action 313, the first node 11 may filter the processed second data based on one or more first criteria. The one or more first criteria may be for selection for performing the determining in Action 319 of the one or more locations.

The filtering in this Action 313 may include filtering the samples based on specified validation criteria or quality thresholds. Samples which do not satisfy such criteria may be discarded during the process. The filtering may be based on domain expertise, such as discarding samples with invalid values of measurements of network parameters, such as RSRP, RSRQ, SINR etc,) or those with poor quality of measurements, e.g., samples with location accuracy below threshold, mode of estimation of parameters including network connection, type etc.

The one or more first criteria may be network parameters, such as RSRP, RSRQ, SINR etc., or quality of measurements, e.g., samples with location accuracy below threshold, mode of estimation of parameters including network connection, type, etc.

For example, the network node 111 may be deployed or relocated to improve one or more particular performance indicators of radio communications, e.g., KPIs. If that is the case, the first node 11 may be understood to not need to analyze and perform computations with all the second data collected, but may instead advantageously reduce the amount of data to process by filtering the processed second data based on the performance indicators of radio communications of interest. This may be understood to reduce the resources that may be required for the determination of the potential candidate locations. Data sanity checks may be additionally performed, such as location accuracy, mode of network connection etc.

### Action 314

In this Action 314, the first node 11 may determine, using the filtered second data, a respective second location of the existing cells 120 serving the geographical area. This may comprise to estimate the locations of cell-towers from the cleaned second data.

The determining in this Action 314 may involve selection of samples corresponding to the available cell identifiers such as Mobile Country Code (MCC), Mobile Network Code (MNC), Public Land Mobile Network (PLMN) code, eNodeB or gNodeB ID, among others. The locations of the existing cells 120 may then be derived by processing the locations of the devices 130, e.g., UE, obtained from these samples by using various methods such as weighted centroids, geographically weighted regression, sector-based methods, among others.

By determining the respective second location of the existing cells 120 in this Action 314, the first node 11 may enable to ultimately derive the potential candidate locations of the network node 111. The advantage of deriving the locations of the existing cells existing from such data may be understood to be that it may be computed from actual measurement reports from the devices, e.g., the devices 130, and hence may be reflective of the “true” operational network KPIs being perceived by users, hence computed in near real-time, as opposed to using cell locations that may be provided by operators, which may be out-dated or not influenced by practical considerations such as traffic, obstructions/coverage etc.

### Action 315

In this Action 315, the first node 11 may determine, using the determined respective second location of the existing cells 120, a respective third location of the existing network nodes 110 in the geographical area. In this Action 315, the first node 11 may leverage crowdsourced data samples from the available time window and geo-spatially process the data samples to derive the respective third locations of the existing network nodes 110, often around the locations of the determined respective first location of the existing network nodes 110, that is, of the candidate utility poles. Otherwise, the first node 11 may derive locations and coverage polygons based on cell and tower identifiers, such as Public Land Mobile Network (PLMN).

The determining in this Action 315 may be performed by combining the cell locations to obtain tower locations using methods such as interpolation, tri-lateration or multi-lateration, among others.

By determining the respective third location of the existing network nodes 110 in this Action 315, the first node 11 may enable to ultimately derive the potential candidate locations of the network node 111 with higher accuracy, as it may be enabled to correlate the location estimated via the first data with that estimated with the second data. This will be explained with further detail later. The estimated tower locations may also be influenced by the determined cell locations. However, by combining with the use of estimated locations from the candidate utility poles, this uncertainty in error may be reduced.

### Action 316

In this Action 316, the first node 11 may determine, using the determined respective second location of the existing cells 120 and the respective third location of the existing network nodes 110, one or more cell coverage polygons in the geographical area.

A cell coverage polygon may be understood as a coverage area, defined as a polygon, of a certain cell. The polygon may be defined by the set of coordinates representing the latitudes and longitudes of its vertices. Further, the polygon may also be determined by a specific network KPI, e.g. a polygon where RSRP<−70 dB.

The cell coverage polygons in this Action 316 may be generated by processing the second data samples using geometric methods such as Voronoi Tessellation, Delaunay triangulation, among others.

By determining the one or more cell coverage polygons in this Action 316, the first node 11 may enable to ultimately derive the potential candidate locations of the network node 111 with higher accuracy, as it may be enabled to estimate the tower location using cell locations derived from cell coverage polygons, which may be derived from network performance parameters.

### Action 317

In this Action 317, the first node 11 may determine a respective second accuracy of the determined at least one of: respective second location of the existing cells 120, respective third location of existing network nodes 110 and one or more cell coverage polygons in the geographical area. In other words, the first node 11 may evaluate the quality or accuracy of the estimated locations of cell-towers as well as the coverage polygons.

This Action 317 may be performed, for example, by the evaluator module managed by the first node 11.

The determining in this Action 317 may be performed by computing metrics based on a comparison with a ground truth of known cell-tower locations and cellular coverage polygons. The metric computation may be performed on distances estimated

By determining the respective second accuracy in this Action 317, the first node 11 may be enabled to know if the respective second location of the existing cells 120, respective third location of existing network nodes 110 and one or more cell coverage polygons in the geographical area have been derived with sufficient accuracy in order to enable to estimate the potential candidate locations of the network node 111, or if collection of further second data may be necessary.

### Action 318

In this Action 318, the first node 11 may output a respective second indication of the determined at least one of: respective second location of the existing cells 120, respective third location of existing network nodes 110 and one or more cell coverage polygons in the geographical area.

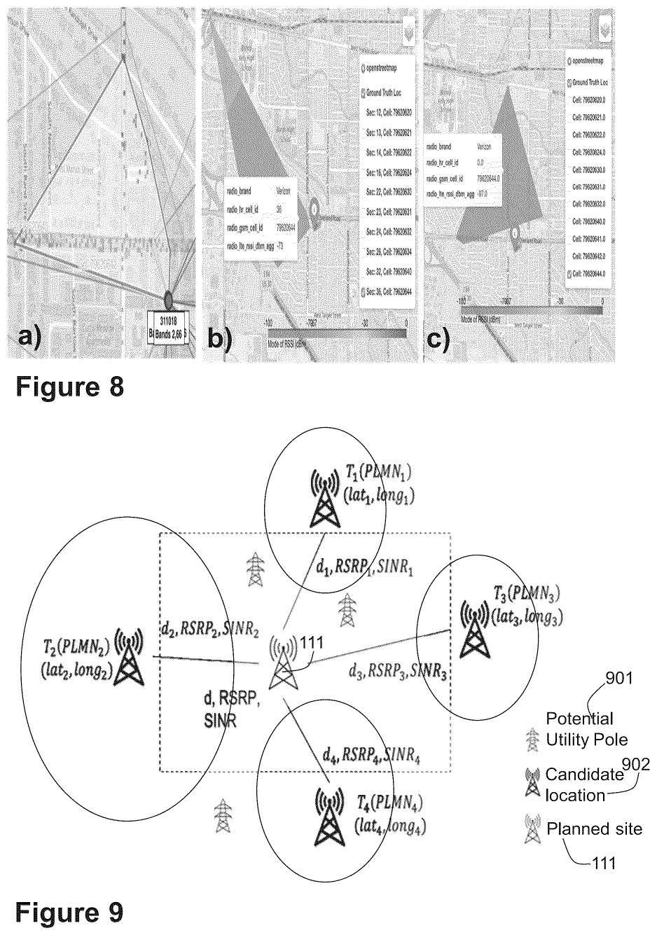

The outputting in this Action 318 may be internal to the first node 11, e.g., to an evaluator module or engine managed by the first node 11, or to another node, e.g., to the second node 12. In some examples, the outputting in this Action 318 may be, for example, on a user interface in a network planning tool. An illustrative example is provided later in FIG. 8.

This Action 318 may be performed once the estimated locations may satisfy the evaluation criteria used in Action 317. The, they may be deployed in e.g., the second node 112, for example, a planning tool, to be consumed by user interfaces.

By outputting the respective second indication in this Action 318, the first node 11 may enable a planning tool to directly use the locations estimated from the CS data, or these may be used in the next Action 319.

### Action 319

According to embodiments herein, the workflows involving the processing of second data, e.g., CS data samples, to generate estimated cell-tower locations and cell coverage polygons may be combined with the approach using CV techniques, on the first data, e.g., street view images, in a manner that may overlay them to exploit their spatio-temporal correlation. Particularly, the task at hand may be to estimate the ideal location, e.g., “d”, which may comprise latitude and longitude, of a new, planned, site based on performance indicators of radio communications, e.g., KPIs such as RSRP or SINR, or may involve upgradation of the site to meet network targets of performance indicators of radio communications. In both cases, this may involve determination as described in this Action 319, and ranking as described in Action 320, of potential candidate locations and the existing network performance parameters.

In this Action 319, the first node 11 determines, by performing a spatio-temporal correlation of the obtained first data and the obtained second data, one or more locations as candidates to place the network node 111 for operation in the communications system 100.

To place may be understood as e.g., to deploy or relocate.

The determining in this Action 319 is performed using machine learning or deep learning.

The determining in this Action 319 may, for example, comprise superposition of second data, e.g., crowdsourced data on first data, e.g., street view images, for utility pole identification and deriving telecommunication network parameters. That is, the determining of the one or more locations in this Action 319 may involve leveraging crowdsourced data samples for cell-tower location and street view images for pole estimation to establish their spatio-temporal correlation. For example, performing Action 319 may enable to identify potential school locations from map terrain views using computer vision algorithms, and use crowdsourced data to estimate coverage at those locations.

The spatio-temporal correlation between second data, e.g., crowd-sourced data, and first data, e.g., street view images, may be leveraged by a multiplicity of methods for network design and planning use-cases. This may, for example, involve introducing attention-based layer(s) in neural (deep) networks. Accordingly, the determining in this Action 319 of the one or more locations may be based on one or more attention-based layers in a neural network.

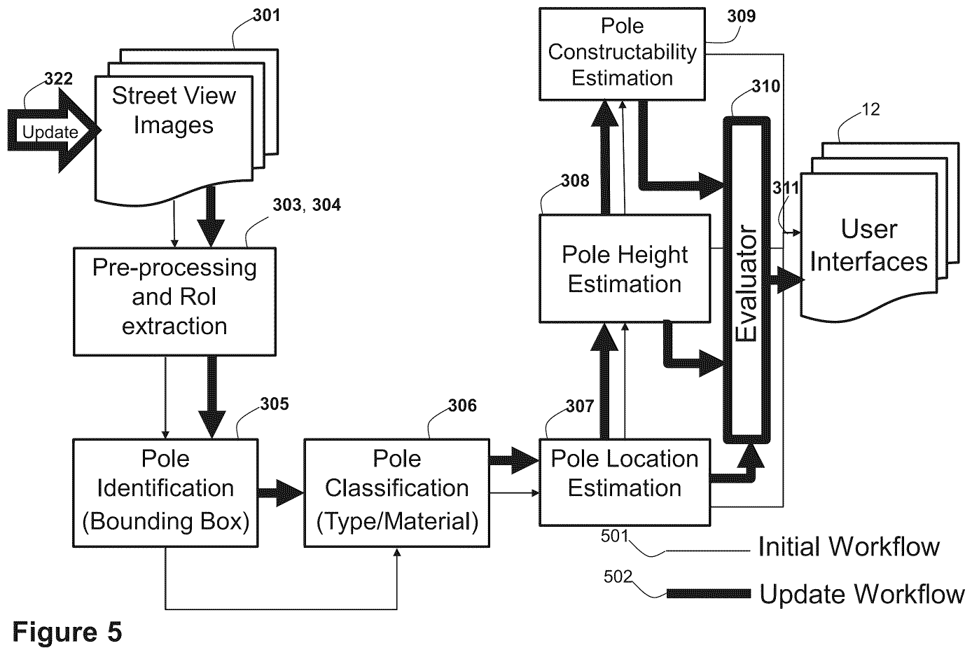

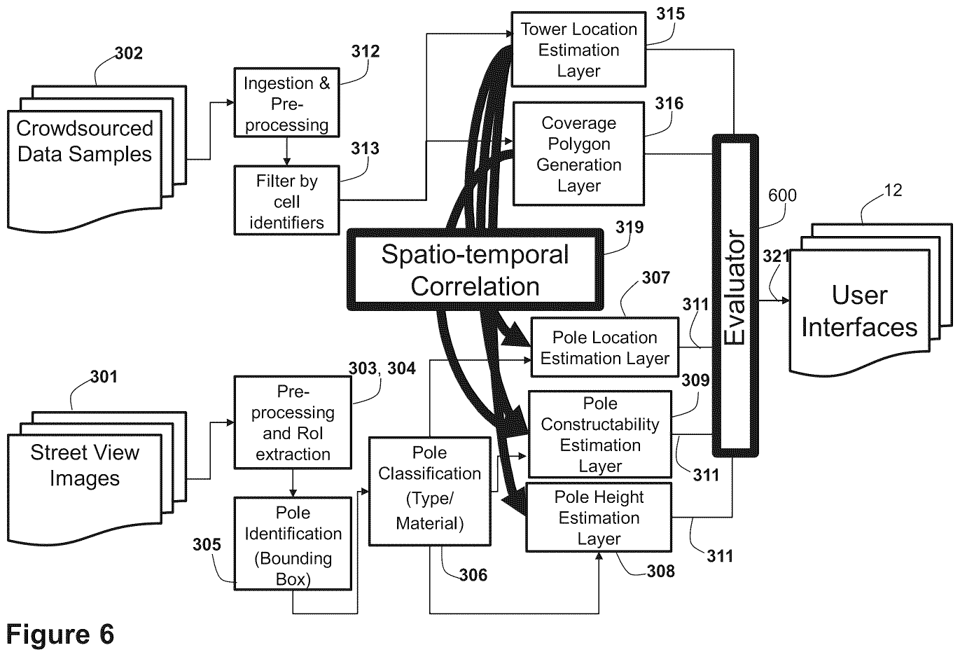

An alternative embodiment may involve a validation layer that may improve the tower location estimated by the second data, e.g., CS data, by aligning it with the location determined from the first data, e.g., street view images, and subsequently determine the cell positions. Such layer(s) may, based on the quality of training data, first data and second data, available, also increase or decrease the weights on the processing methods adopted for the first data and second data, such as those in FIGS. 5 and 6, which will be described later, or others. Accordingly, in some embodiments, the determining in this Action 319 of the one or more locations may be based on a validation layer that may align the determined respective first location of the existing network nodes 110 with the respective third location of existing network nodes 110.

The determining in this Action 319 of the one or more locations may be based on the determined: identification, classification, respective first location, respective height, and the one or more aspects only after a respective first accuracy threshold may have been achieved in Action 310. The determined identification, classification, respective first location, respective height, and the one or more aspects may be used as input in machine learning or deep learning.

The determining in this Action 319 of the one or more locations may be based on the determined respective second location of the existing cells 120, the respective third location of the existing network nodes 110 and the determined one or more cell coverage polygons. The determined respective second location of the existing cells 120, the respective third location of the existing network nodes 110 and the determined one or more cell coverage polygons may be used as input in machine learning or deep learning.

The determining in this Action 319 of the one or more locations may be based on the determined respective second location of the existing cells 120, the respective third location of existing network nodes 110 and the determined one or more cell coverage polygons only after a respective second accuracy threshold may have been achieved.

The approach of embodiments herein may be understood to be advantageously based on an estimation of the one or more locations based on spatio-temporal correlation. This may, for example, increase, or reduce, the confidence in the location or height of one of the existing network nodes 110 estimated by a CV technique from the first data, e.g., street view images, if these are not supplemented, or validated, by network performance parameters available from CS data samples collected at that time window.

Embodiments herein may for example, change, or intelligently select, based on evaluation parameters specified in the evaluator module, the method(s) to be used in the second data processing pipeline for estimating the cell-tower location or generation of coverage polygons based on the output of the location and bounding box of one or more utility pole(s) estimated by the CV approach using first data, e.g., street view images, in that region. This may, in turn, result in improved accuracy of the generated outputs.

In some embodiments, the determining in this Action 319 of the one or more locations may be to meet one or more KPI targets, such as for example, coverage, e.g., RSRP, and capacity, e.g., throughput requirements. The determining in this Action 319 may comprise to derive candidate locations, e.g., T₁, T₂, T₃ or T₄, along with associated network performance parameters such as for example, RSSI or SINR.

By the first node 11 determining in this Action 319 the one or more locations by performing the spatio-temporal correlation of the obtained first data and the obtained second data, the first node 11 may enable to ensure that the outputs generated by the processing pipeline using both the CS data processing approach and CV based methods that may process the first data to generate inputs for the user interfaces of the network planning tool may be spatio-temporally correlated, and thus may result in improved accuracy estimation by the first node 11, e.g., by an evaluator module managed by the first node 11.

From a broader perspective, this may also enable to improve and streamline the RF, or network, design workflow for various network planning and design use-cases. It may also enable the generation of a ranking or recommendation of potential sites and network parameters from the planning tools for use by the design team.

Embodiments herein may be employed either to largely replace, or augment, the existing site surveying process. The inputs that may be required by the site acquisition team may be largely generated by the estimated tower locations, network parameters or KPIs and utility pole locations generated according to embodiments herein. This may be understood to significantly lower the costs of performing the survey and result in societal energy benefits, while also providing an automated pipeline for processing incoming data and updating candidate locations that may be recommended by the approach described herein.

### Action 320

The first node 11 may also generate a ranking of the derived candidate locations, e.g., based on the defined criteria or KPI targets, which may be useful for downstream network planning.

In this Action 320, the first node 11 may rank the one or more locations based on one or more second criteria.

The one or more second criteria may be for example, a combination of one or more parameter(s) captured by the second data, which may include signal strength measures, uplink/downlink throughput or latency measurements, among others.

Threshold(s) on these parameter values, e.g., based on domain or functional knowledge, may also additionally by incorporated in the ranking mechanism. This may help the user easily identify candidate locations and also have supplementary information about the network parameters derived from the CS data.

By ranking the one or more locations in this Action 320, the first node 11 may enabled to provide a recommendation of which of the one or more locations may be most suitable to place the network node 111, given a particular goal to be accomplished by the use case.

### Action 321

In this Action 321, the first node 11 outputs an indication of the determined one or more locations. The indication may be understood to be a third indication. Action 321 may be performed post the evaluation of the accuracy of the estimates by the first node 11, e.g., the evaluator module at the first node 11. The output indication may, e.g., be consumed by user interfaces in network planning tools.

The indication in Action 319 may indicate the ranked one or more locations from Action 320.

In some examples, the outputting in this Action 321 may be internal to the first node 11, e.g., to an evaluator module or engine managed by the first node 11, while in some embodiments, the outputting in this Action 321 may be to the second node 12 operating in the communications system 100. The second node 12 may be e.g., the user interface of a network planning tool.

### Action 322

The input to the pipeline may be the first data, e.g., street-view images, and the workflow may comprise an initial and update workflow. The update workflow may be defined for the first data-based approach, e.g., CV-based approach, when new street view images may become available, which may involve re-estimation and re-evaluation of the accuracy, and update in the deployed user interfaces. That is, updating the images and processing them when, for example, clutter may change with time.

In this Action 322, the first node 11 may iterate the processing 303 of the obtained first data, the extracting 304, the filtering 305 of the processed first data, the determining 305 of the identification, the determining 306 of the classification, the determining 307 of the respective first location, the determining 308 of the respective height, and the determining 309 of the one or more aspects of constructability as new first data may be obtained.

By performing the iterating in this Action 322, the first node 11 may capture and exploit spatial and temporal changes for improved performance evaluation of the processing pipeline. This may in turn enable, with every update, to incrementally refine the estimated one or more locations of the network node 111, and associated coverage/performance derived data for efficiently assisting network design and planning.

### Action 323

Similar to the update in the workflow in the CV pipeline, the input to the pipeline may be the second data, e.g., CS data, and the workflow may comprise an initial and update workflow. Sample values of the second data may change with time due to network changes and clutter changes. When new second data samples are available, the update workflow may be executed which may involve that the first node 11 may perform re-estimates based on new second data, that is, re-estimation of the cell-tower locations and coverage polygons. If the re-estimated locations result in an improvement over the existing estimations as determined by the evaluator, the new locations are now used as input to the user-interfaces

The update workflow may be defined for the second data-based approach, e.g., the CS data-based approach, when new second data may become available, which may involve re-estimation and re-evaluation of the accuracy and update in the deployed user interfaces.

In this Action 323, the first node 11 may iterate the processing 312 of the obtained second data, the filtering 313 of the processed second data, the determining 314 of the respective second location, the determining 315 of the respective third location and the determining 316 of the one or more cell coverage polygons as new second data may be obtained.

As it may be understood that the network performance parameters of an area may change over time due to various factors, such as number of users or operators or supported technologies, as well as that potential utility poles available in an area or space, may change over time, embodiments herein may be understood to exploit this spatio-temporal correlation by periodically processing the CS data and street view images through the respective pipelines to generate the respective outputs.

By performing the iterating in this Action 323, the first node 11 may capture and exploit spatial and temporal changes for improved performance evaluation of the processing pipeline. This may in turn enable, with every update, to incrementally refine estimated one or more locations of the network node 111, e.g., site locations, and associated coverage/performance derived data for efficiently assisting network design and planning.

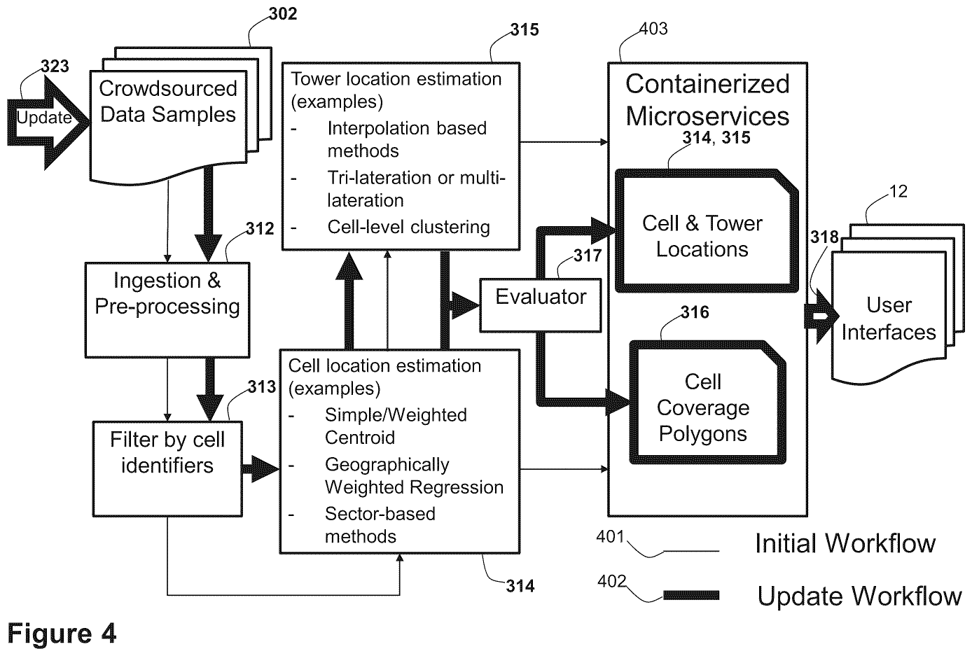

FIG. 4 is a schematic diagram illustrating a partial view of the approach followed by embodiments herein, concerning usage of CS data. In particular, FIG. 4 depicts an exemplary approach used in planning tools that may use CS data according to embodiments herein. The boxes with thicker lines represent the outputs generated by the processing pipeline which may be consumed by user interfaces in the planning tools such as the second node 12. The approach using CS data may be understood to have two workflows. The first workflow 401 may be understood to comprise the initial processing according to Action 312 of the available CS data samples obtained according to Action 302. This may involve ingestion of the samples from a storage medium to a processing medium, followed by pre-processing steps which may include filtering the samples according to Action 313, based on specified validation criteria or quality thresholds. Samples which may not satisfy such criteria may be discarded during the process. The next step in the pipeline may be to filter the CS data samples according to Action 313. This may involve selection of samples corresponding to the available cell identifiers such as Mobile Country Code (MCC), Mobile Network Code (MNC), Public Land Mobile Network (PLMN) code, eNodeB or gNodeB ID, among others. The locations of cells may then be derived according to Action 314 by processing the locations of the devices 130, e.g., UE, obtained from these samples by using various methods such as weighted centroids, geographically weighted regression, sector-based methods, among others. These cell locations may be combined to obtain tower locations according to Action 315 using methods such as interpolation, tri-lateration or multi-lateration, among others. In addition, cell coverage polygons may also be generated according to Action 316 by processing these samples using geometric methods. The next step may comprise the evaluation, according to Action 317, of the quality or accuracy of the estimated locations of cell-towers as well as the coverage polygons. This may be done by computing metrics based on comparison with a ground truth of known cell-tower locations and cellular coverage polygons. It may be noted here that, due to availability of new data, the estimated locations may change from those that may have been estimated in previous iteration(s). As such, the evaluation step may now additionally comprise choosing the location(s) with lower error across the iterations. This may, also involve, estimation of correlation between results obtained across iterations, and retaining/discarding estimated locations based on computation of such correlation. Once the estimated locations may satisfy such evaluation criteria, they may be deployed, according to Action 318, in the planning tool to be consumed by user interfaces. When new CS data samples may become available, the update workflow 402 may be executed according to Action 323, which may involve re-estimation of the cell-tower locations and coverage polygons. If the re-estimated locations result in an improvement over the existing estimations as determined by the first node 11, e.g., an evaluator module managed by the first node 11, the new locations may now be used as input to the user-interfaces such as the second node 12.

FIG. 5 is a schematic diagram illustrating a partial view of the approach followed by embodiments herein, concerning usage of a CV based approach. In particular, FIG. 5 depicts an exemplary approach using CV based approaches for processing street view images. The input to the pipeline may be street-view images obtained according to Action 301, and the workflow may comprise an initial workflow 501 and an update workflow 502. During the initial workflow 501, with the street view images available initially as obtained according to Action 301, they may be pre-processed for cleaning, noise-removal or other quality criteria according to Action 303. The Region of Interest (Rol) may also be extracted according to Action 304. Further, machine learning or deep learning models may be used to estimate the bounding box of the pole in the image according to Action 305. Further, such deep learning models may also be used to estimate or predict the pole location according to Action 307, height according to Action 308 or constructability aspects according to Action 309. Post the evaluation of the accuracy of the estimates by the evaluator module according to Action 310, the outputs may be consumed by user interfaces in planning tools such as the second node 12. Similar to the update in the workflow in the CS pipeline, an update workflow 502 may also be defined for the CV-based approach when new street view images may become available, which may involve, according to Action 322, re-estimation and re-evaluation of the accuracy and update in the user interfaces according to Action 311.

FIG. 6 is a schematic diagram illustrating an overview of the approach followed by embodiments herein. As depicted in FIG. 6, the approach followed by embodiments herein, may be understood to combine the workflows involving the processing of the second data, e.g., CS data samples, to generate estimated cell-tower locations and cell coverage polygons with the approach using CV techniques on first data, e.g., street view images, in a manner that may overlay them to exploit their spatio-temporal correlation. As it is understood that the network performance parameters of an area may change over time due to various factors such as number of users or operators or supported technologies, as well as that potential utility poles available in an area or space may change over time, embodiments herein may be understood to exploit this spatio-temporal correlation by periodically processing the CS data and street view images through the respective pipelines to generate the respective outputs, using estimation based on spatio-temporal correlation. This may, for example, increase, or reduce, the confidence in the location or height of a pole estimated by a CV technique from street view images if these may not be supplemented, or validated, by network performance parameters available from CS data samples collected at that time window. Alternatively, embodiments herein may also change, or intelligently select, based on evaluation parameters specified in the evaluator module, the method(s) to be used in the CS data processing pipeline for estimating the cell-tower location or generation of coverage polygons based on the output of the location and bounding box of one or more utility pole(s) estimated by the CV approach using street view images in that region. This may, in turn, result in improved accuracy of the generated outputs. In totality, embodiments herein may ensure that the outputs generated by the processing pipeline using both the CS data processing approach and CV based methods that process street view images to generate inputs according to Action 321 for the user interfaces of the network planning tool that may be spatio-temporally correlated, and thus may result in improved accuracy estimation by the evaluator module. The initial and update workflows, shown in FIGS. 4 and 5, simplified in this FIG. 6, may thus be enhanced by the spatio-temporal estimation performed by the first node 11, e.g., by a spatio-temporal estimation module 600 according to Action 319, that may work with the evaluation module in the pipeline. From a broader perspective, this may improve and streamline the RF, or network, design workflow for various network planning and design use-cases. It may also enable the generation of a ranking, or recommendation, of potential sites and network parameters from the planning tools for use by the design team.

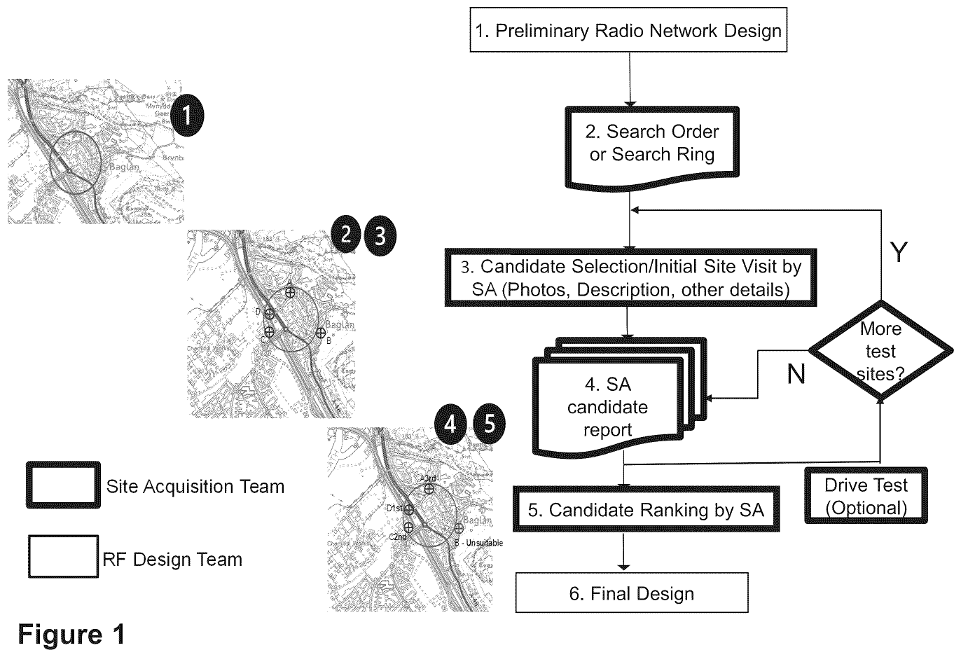

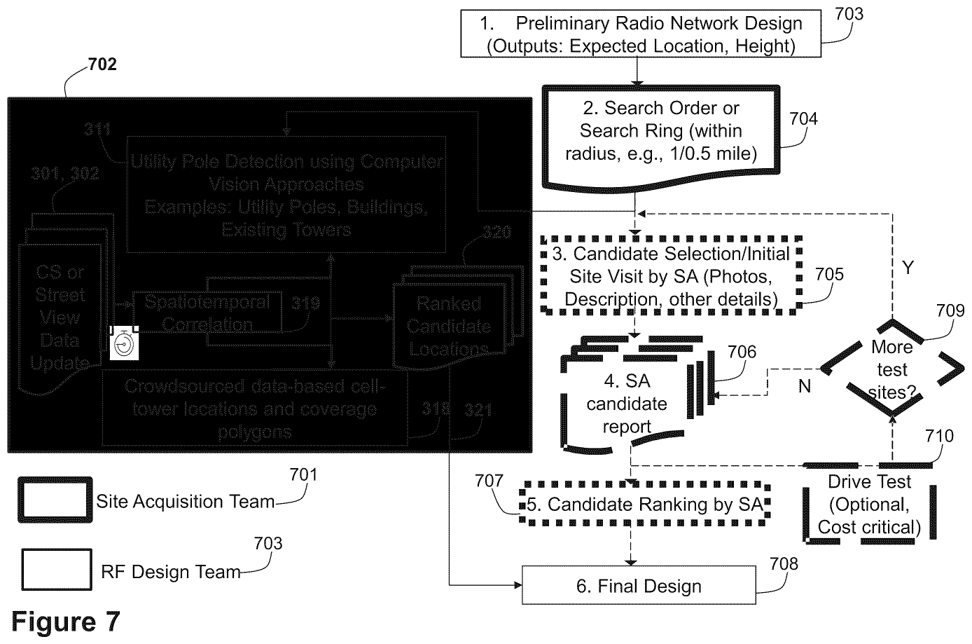

FIG. 7 is a schematic diagram showing an illustrative workflow of embodiments herein the network planning workflow. The boxes with thicker lines represent the workflow of the Site Acquisition (SA) team 701 may be augmented as by actions performed by the first node 11, framed by a rectangular box 702 to the left of the Figure. The boxes with dotted lines and connecting dotted lines represent the original workflow during the site survey process. Actions 1-6 on the right side of FIG. 7 would have a description corresponding to that provided in FIG. 1. Action 1 and Action 6 may be performed by the RF Design Team 703. Embodiments herein may involve processing streams, or batches, of incoming second data, e.g., CS data, according to Action 302, or first data, e.g., street view images, according to Action 301, through a model that may exploit their spatio-temporal correlation according to Action 319, to generate ranked candidate locations according to Action 320. The outputted locations in accordance with Action 321 may then be employed either to largely replace, or augment, the existing site surveying process. The inputs required by the Site Acquisition Team 701 may now be largely generated by the estimated tower locations, network parameters or KPIs and utility pole locations generated according to embodiments herein. This may significantly lower the costs of performing the survey and result in societal energy benefits, while also providing an automated pipeline for processing incoming data and updating candidate locations that may be recommended by embodiments herein. FIG. 7 illustrates how the approach may improve site design planning using an example with multiple crowdsourced datasets, also varying over the time window during which the samples may have been collected. The variations in cell coverage polygons may be determined by the availability of crowdsourced data, as well as other factors such as the density of the devices 130 and frequency of connection tests performed.

FIG. 8 is another schematic diagram illustrating, as an illustrative example, the coverage polygons for a cell generated using three different crowdsourced data providers a), b), and c) for data, that is, samples collected during three distinct time periods, varying from a few weeks to six months, for the same cell, associated with a tower. The marker represented as the greyed oval represents the location of the tower, which may have been determined by using a utility pole detection approach. The changes in the cell regions identified by the approach may be correlated with the utility poles according to Action 319, such as in cases where a site location may support multiple operators. At a particular location, there may be multiple operators having multiple antennas installed on the tower, to cater to different service types or traffic loads, which may spawn different cells, as well as coverage polygons. In such cases, the second data, e.g., CS data, may contain information about cells to which devices 130 may have latched to for execution of the measurement tests. The association of these cells with the number of antennas/operators over time may need to be established by a spatio-temporal correlation with the street view images. FIG. 8 illustrates that it may be understood to be advantageous to jointly use the data sources, crowdsourced data and street-view images, to capture the spatio-temporal correlation at the site locations, for effective execution of site design planning use-cases. The estimated locations of the cells and tower using the second data, e.g., CS data, may depend on the amount of available data in a time duration, as well as its quality, as shown by the varying shape of the coverage polygons in the three plots. This highlights the importance of the need to correlate such estimated locations and cells with image data, as performed according to embodiments herein.

FIG. 9 is another schematic diagram illustrating a determined location of the network node 111 performed according to embodiments herein. The task at hand may be to estimate the ideal location d, comprising latitude and longitude, of a new, planned, site for network node 111, based on KPIs such as RSRP or SINR, or may involve upgradation of the site to meet network KPI targets. In both cases, this may involve determination, and ranking, of potential candidate locations and the existing network performance parameters. According to embodiments herein, the first data, e.g., street view images, available during the time window may be processed by machine learning or deep learning models to estimate their locations, height, or other constructability parameters. This may result in the generation of potential utility poles 901 according to Action 311. However, at this stage, there may be understood to be no network performance data available to supplement the candidate sites. In the second stage, crowdsourced data samples from the available time window may be leveraged and the data samples may be geo-spatially processed to derive their locations according to Action 315, often around the locations of the candidate utility poles. Otherwise locations and coverage polygons may be derived based on cell and tower identifiers, such as PLMN. Candidate locations T₁, T₂, T₃ or T₄ 902 may thus be derived according to Action 315 along with associated network performance parameters such as RSSI or SINR. As depicted, a first candidate location T₁ corresponds to a first latitude lat₁ and a first longitude long₁, or d₁, as well as a first RSRP RSRP₁, and a first SINR SINR₁. A second candidate location T₂ corresponds to a second latitude lat₂ and a second longitude long₂, or d₂, as well as a second RSRP RSRP₂, and a second SINR SINR₂. A third candidate location T₃ corresponds to a third latitude lat₃ and a third longitude long₃, or d₃, and a third SINR SINR₃. A fourth candidate location T₁ corresponds to a fourth latitude lat₄ and a fourth longitude long₄, or d₄, as well as a fourth RSRP RSRP₄, and a fourth SINR SINR₄. Candidate locations 902 may be understood to refer to those estimated from the second data, while potential utility poles 901 may be estimated by CV methods from the first data. These may be separate based on the determination from the respective flows, based on data, however, when combined, these may ideally represent the same. The spatio-temporal correlation between second data, e.g., crowd-sourced data, and first data, e.g., street view images, may be leveraged by a multiplicity of methods. This may, for example, involve introducing attention-based layer(s) in neural (deep) networks. An alternative embodiment may involve a validation layer that may improve the tower location estimated by the second data by aligning it with the location determined from the first data, and subsequently determine the cell positions. Such layer(s) may, based on the quality of training data, e.g., CS and image data, available, may also increase or decrease the weights on the processing methods adopted for the CS and image data, such as those in FIGS. 5 and 5, or others in existing methods. Summarily, as new data may become available with time, embodiments herein may involve: updating the first data, e.g., images, and processing them when clutter may change with time. Second data, e.g., CS data sample, values may change with time due to network changes and clutter changes, thus the first node 11 may re-estimate based on new data. The first node 11 may capture and exploit spatial and temporal changes for improved performance evaluation of the processing pipeline. The first node 11 may also generate a ranking of the derived candidate locations based on the defined criteria or KPI targets, which may be useful for downstream network planning. The ranking may be determined by combination of one or more parameter(s) captured by the second data, e.g., CS data, which may include signal strength measures, uplink/downlink throughput or latency measurements, among others. Threshold(s) on these parameter values, based on domain or functional knowledge, may also additionally be incorporated in the ranking mechanism. This may help a user easily identify candidate locations and also have supplementary information about the network parameters derived from the CS data.

As a summarized view of the foregoing, embodiments herein may be understood to exploit the spatio-temporal correlation between the second data, e.g., crowdsourced data and the first data, e.g., street-view images, using the respective statistical or machine, deep, learning pipelines that may process these types of data to improve the estimated site locations and associated network performance attributes for radio network design and capacity planning use-cases.

One advantage of embodiments herein may be understood to be that since 5G may require densification of sites for coverage and capacity in the thousands, the described approach may introduce a scalable automation in the network design and planning pipeline.

Another advantage of embodiments herein may be understood to be that coverage holes or capacity issues may be identified or detected with second e.g., CS, data, which may be useful input for the network planning and design workflow.

A further advantage of embodiments herein may be understood to be to enable to enhance the ability of the planning tools to provide new sites for capacity or coverage expansion that may incorporate geo-spatial and network parameters.

Yet another advantage of embodiments herein may be understood to be that they may enable to rank the potential candidates. This may be achieved by processing the first data, e.g., street view images, using computer vision to get the candidate locations, and available heights for the utility poles. The first node 11 may subsequently overlay the second, e.g., CS, data.

Furthermore, embodiments herein may advantageously Reduce, or alleviate the efforts for manual surveying, improve design lead times, improve quality of candidate selection and reduce CAPEX significantly.

The approach followed by embodiments herein may also pro-actively identify areas for improving network coverage and capacity.

Furthermore, embodiments herein may advantageously assist the network planning & design teams in potential candidate selection of cell towers, e.g., using CS and CV, for new installations.

Yet another advantage of embodiments herein may be understood to be that they may enable to improve the network. This may be understood to be because embodiments herein may also be used to re-locate the existing site locations to new locations if the benefit may be high, for example, if the CS data may indicate that network KPIs are better for a candidate site. This may, additionally, result in lower CAPEX compared to new site installation.

Another advantage of embodiments herein may be understood to be to enable an eventual improvement in customer experience in terms of coverage and capacity.

The potential use-cases that may benefit from embodiments herein may comprise pre-design/planning, pro-active cell design, school connectivity insights, e.g., identify potential school locations from map terrain views using computer vision algorithms, and usage of crowdsourced data to estimate coverage at those locations.

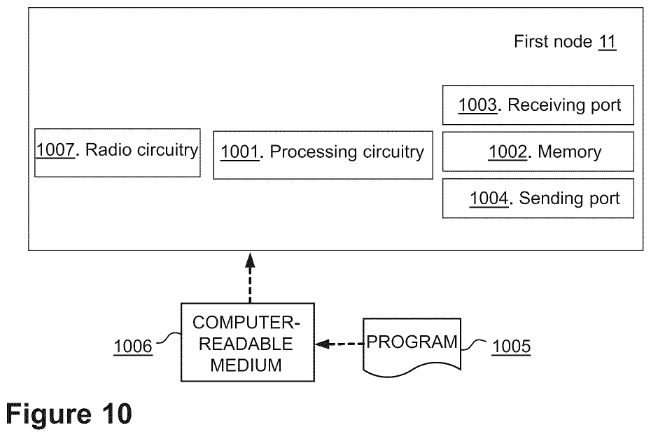

FIG. 10 depicts an example of the arrangement that the first node 11 may comprise to perform the method described in FIG. 3 and/or FIGS. 4-9. The first node 11 may be understood to be for handling the location of the network node 111 in the geographical area for operation in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 11 and will thus not be repeated here. For example, the performance indicators of radio communications may be configured to be KPIs.

The first node 11 is configured to, e.g., by means of an obtaining unit within the first node 11, obtain the first data. The first data is configured to indicate the images of the geographical area over the first time period.

The first node 11 is further configured to, e.g., by means of the obtaining unit within the first node 11, obtain the second data. The second data is configured to indicate the data samples of the performance indicators of radio communications, during the first time period, of the devices 130 in the geographical area.

The first node 11 is also configured to, e.g., by means of a determining unit within the first node 11, determine, by performing the spatio-temporal correlation of the first data and the second data configured to be obtained, the one or more locations as candidates to place the network node 111 for operation in the communications system 100. The determining is configured to be performed using machine learning or deep learning.

The first node 11 is further configured to, e.g., by means of an outputting unit within the first node 11, output the indication of the one or more locations configured to be determined.

In some embodiments, the determining of the one or more locations may be configured to be to meet the one or more KPI targets.

The first node 11 may be additionally configured to, e.g., by means of a processing unit within the first node 11, process the first data configured to be obtained for subsequent analysis.

In some embodiments, the first node 11 may be further configured to, e.g., by means of an extracting unit within the first node 11, extract the region of interest from the first data configured to be processed.

In some embodiments, the first node 11 may be further configured to, e.g., by means of the determining unit, determine, using the first data configured to be extracted, the identification of the existing network nodes 110 in the region of interest configured to be extracted or geographical area.

In some embodiments, the first node 11 may be further configured to, e.g., by means of the determining unit, determine, using the first data configured to be extracted, the classification of the existing network nodes 110 in the region of interest configured to be extracted or geographical area.

In some embodiments, the first node 11 may be further configured to, e.g., by means of the determining unit within the first node 11, determine, using the first data configured to be extracted, the respective first location of the existing network nodes 110 in the region of interest configured to be extracted or geographical area.

In some embodiments, the first node 11 may be further configured to, e.g., by means of the determining unit within the first node 11, determine, using the first data configured to be extracted, the respective height of the existing network nodes 110 in the extracted region of interest or geographical area.

In some embodiments, the first node 11 may be further configured to, e.g., by means of the determining unit within the first node 11, determine, using the first data configured to be extracted, the one or more aspects of constructability in the region of interest configured to be extracted or geographical area.

In some embodiments, the first node 11 may be further configured to, e.g., by means of an iterating unit within the first node 11, iterate the processing of the first data configured to be obtained, the extracting, the determining of the identification, the determining of the classification, the determining of the respective first location, the determining of the respective height, and the determining of the one or more aspects of constructability as new first data may be obtained.

The determining of the one or more locations may be configured to be based on the at least one of: identification, classification, respective first location, respective height, and one or more aspects, configured to be determined.

In some embodiments, the first node 11 may be further configured to, e.g., by means of the determining unit within the first node 11, determine the respective first accuracy of the at least one of: the identification of existing network nodes 110, the classification of the existing network nodes 110, the respective first location of existing network nodes 110, the respective height of the existing network nodes 110 and the one or more aspects of constructability configured to be determined. The determining of the one or more locations may be configured to be based on the: identification, classification, respective first location, respective height, and one or more aspects configured to be determined only after the respective first accuracy threshold may have been achieved.

In some embodiments, the first node 11 may be further configured to, e.g., by means of the outputting unit within the first node 11, output the respective first indication of the determined at least one of: identification, classification, respective first location, respective height, and the one or more aspects.

In some embodiments, at least one of: the determining of the classification, the determining of the respective first location, the determining of the respective height, and the determining of the one or more aspects of constructability, may be configured to be performed using computer vision methods.

In some embodiments, the first node 11 may be further configured to, e.g., by means of the processing unit within the first node 11, process the second data configured to be obtained for subsequent analysis.

In some embodiments, the first node 11 may be further configured to, e.g., by means of a filtering unit within the first node 11, filter the second data configured to be processed based on one or more first criteria for selection for performing the determining of the one or more locations.

In some embodiments, the first node 11 may be further configured to, e.g., by means of the determining unit within the first node 11, determine, using the filtered second data, the respective second location of existing cells 120 configured to be serving the geographical area.

In some embodiments, the first node 11 may be further configured to, e.g., by means of the determining unit within the first node 11, determine, using the respective second location of the existing cells 120 configured to be determined, the respective third location of existing network nodes 110 in the geographical area.

In some embodiments, the first node 11 may be further configured to, e.g., by means of the determining unit within the first node 11, determine, using the respective second location of the existing cells 120 configured to be determined and the respective third location of the existing network nodes 110, the one or more cell coverage polygons in the geographical area.

In some embodiments, the first node 11 may be further configured to, e.g., by means of the iterating unit within the first node 11, iterate the processing of the second data configured to be obtained, the filtering of the second data configured to be processed, the determining of the respective second location, the determining of the respective third location and the determining of the one or more cell coverage polygons as new second data may be obtained.

The determining of the one or more locations may be configured to be based on the respective second location of the existing cells 120 configured to be determined, the respective third location of the existing network nodes 110 and the one or more cell coverage polygons configured to be determined.

In some embodiments, the first node 11 may be further configured to, e.g., by means of the determining unit within the first node 11, determine the respective second accuracy of the at least one of: respective second location of the existing cells 120, respective third location of existing network nodes 110 and one or more cell coverage polygons in the geographical area configured to be determined. The determining of the one or more locations may be configured to be based on the respective second location of the existing cells 120 configured to be determined, the respective third location of existing network nodes 110 and the one or more cell coverage polygons configured to be determined, only after may be respective second accuracy threshold may be configured to have been achieved.

In some embodiments, the first node 11 may be further configured to, e.g., by means of the outputting unit within the first node 11, output the respective second indication of the at least one of: respective second location of the existing cells 120, respective third location of existing network nodes 110 and one or more cell coverage polygons in the geographical area configured to be determined.

In some embodiments, the first node 11 may be further configured to, e.g., by means of a ranking unit within the first node 11, rank the one or more locations based on the one or more second criteria. The indication may be configured to indicate the one or more locations configured to be ranked.

In some embodiments, at least one of the following options may apply. According to a first option, the determining of the one or more locations may be configured to be based on the one or more attention-based layers in a neural network. According to a second option, the determining of the one or more locations may be configured to be based on the validation layer that may be configured to align the respective first location of the existing network nodes 110 configured to be determined with the respective third location of existing network nodes 110.

In some embodiments, at least one of the following options may apply. According to a first option, the images may be configured to be street-view images, drone images or digital images. According to a second option, the second data may be configured to be crowdsourced data. According to a third option, the communications system 100 may be configured to be a 5G system. According to a fourth option, the outputting may be configured to be to the second node 12 configured to be operating in the communications system 100.

The embodiments herein in the first node 11 may be implemented through one or more processors, such as a processing circuitry 1001 in the first node 11 depicted in FIG. 10, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 11. One such carrier may be in the form of a CD ROM disc. It is however feasible with other data carriers such as a memory stick. The computer program code may furthermore be provided as pure program code on a server and downloaded to the first node 11.

The first node 11 may further comprise a memory 1002 comprising one or more memory units. The memory 1002 is arranged to be used to store obtained information, store data, configurations, schedulings, and applications etc. to perform the methods herein when being executed in the first node 11.

In some embodiments, the first node 11 may receive information from, e.g., any of the second node 12, the third node 113, the fourth node 114, the fifth node, the another node and/or another structure in the computer system 100, through a receiving port 1003. In some embodiments, the receiving port 1003 may be, for example, connected to one or more antennas in first node 11. In other embodiments, the first node 11 may receive information from another structure in the computer system 100 through the receiving port 1003. Since the receiving port 1003 may be in communication with the processing circuitry 1001, the receiving port 1003 may then send the received information to the processing circuitry 1001. The receiving port 1003 may also be configured to receive other information.

The processing circuitry 1001 in the first node 11 may be further configured to transmit or send information to e.g., any of the second node 12, the third node 113, the fourth node 114, the fifth node, the another node and/or another structure in the computer system 100, through a sending port 1004, which may be in communication with the processing circuitry 1001, and the memory 1002.

Those skilled in the art will also appreciate that the units comprised within the first node 11 described above as being configured to perform different actions, may refer to a combination of analog and digital circuits, and/or one or more processors configured with software and/or firmware, e.g., stored in memory, that, when executed by the one or more processors such as the processing circuitry 1001, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 11 described above as being configured to perform different actions described above may be implemented as one or more applications running on one or more processors such as the processing circuitry 1001.

Thus, the methods according to the embodiments described herein for the first node 11 may be respectively implemented by means of a computer program 1005 product, comprising instructions, i.e., software code portions, which, when executed on at least one processing circuitry 1001, cause the at least one processing circuitry 1001 to carry out the actions described herein, as performed by the first node 11. The computer program 1005 product may be stored on a computer-readable storage medium 1006. The computer-readable storage medium 1006, having stored thereon the computer program 1005, may comprise instructions which, when executed on at least one processing circuitry 1001, cause the at least one processing circuitry 1001 to carry out the actions described herein, as performed by the first node 11. In some embodiments, the computer-readable storage medium 1006 may be a non-transitory computer-readable storage medium, such as a CD ROM disc, or a memory stick. In other embodiments, the computer program 1005 product may be stored on a carrier containing the computer program 1005 just described, wherein the carrier is one of an electronic signal, optical signal, radio signal, or the computer-readable storage medium 1006, as described above.

The first node 11 may comprise a communication interface configured to facilitate, or an interface unit to facilitate, communications between the first node 11 and other nodes or devices, e.g., any of the second node 12, the third node 113, the fourth node 114, the fifth node, the another node and/or another structure in the computer system 100. The interface may, for example, include a transceiver configured to transmit and receive radio signals over an air interface in accordance with a suitable standard.

In other embodiments, the first node 11 may comprise a radio circuitry 1007, which may comprise e.g., the receiving port 1003 and the sending port 1004.

The radio circuitry 1007 may be configured to set up and maintain at least a wireless connection with the any of the second node 12, the third node 113, the fourth node 114, the fifth node, the another node and/or another structure in the computer system 100. Circuitry may be understood herein as a hardware component.

Hence, embodiments herein also relate to the first node 11 operative to operate in the computer system 100. The first node 11 may comprise the processing circuitry 1001 and the memory 1002, said memory 1002 containing instructions executable by said processing circuitry 1001, whereby the first node 11 is further operative to perform the actions described herein in relation to the first node 11, e.g., in FIG. 2, and/or FIGS. 6-9.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. Rahman, Mostafizur, Mohammad Arif Hossain, and Murat Yuksel. “Multi-Operator Cell Tower Locations Prediction from Crowdsourced Data.” 2021 International Conference on Computer Communications and Networks (ICCCN). IEEE, 2021.
2. Mangla, Tarun, et al. “A Tale of Three Datasets: Towards Characterizing Mobile Broadband Access in the United States.” arXiv preprint arXiv:2102.07288 (2021).
3. Neidhardt, Eric, et al. “Estimating locations and coverage areas of mobile network cells based on crowdsourced data.” 6th Joint IFIP Wireless and Mobile Networking Conference (WMNC). IEEE, 2013.
4. Venanzi, Matteo, Alex Rogers, and Nicholas R. Jennings. “Trust-based fusion of untrustworthy information in crowdsourcing applications.” (2013): 829-836.
5. Fida, Mah-Rukh, and Mahesh K. Marina.“Uncovering mobile infrastructure in developing countries with crowdsourced measurements.” Proceedings of the Tenth International Conference on Information and Communication Technologies and Development. 2019.
6. Li, Zhijing, et al. “Identifying value in crowdsourced wireless signal measurements.” Proceedings of the 26th International Conference on World Wide Web. 2017.
7. Madariaga, Diego, et al. “Improving Signal-Strength Aggregation for Mobile Crowdsourcing Scenarios.” Sensors21.4 (2021): 1084.
8. Alimpertis, Emmanouil, et al. “City-wide signal strength maps: Prediction with random forests.” The World Wide Web Conference. 2019.
9. Ghasemi, Amir, and Janaki Parekh. “Deep Learning based Localization of LTE eNodeBs from Large Crowdsourced Smartphone Datasets.” 2021 IEEE 93rd Vehicular Technology Conference (VTC2021-Spring). IEEE, 2021.
10. Eller, Lukas, et al. “Localizing Basestations from End-User Timing Advance Measurements.” IEEE Access (2022).
1. Liu, Yaxi, et al. “Multi-criteria coverage map construction based on adaptive triangulation-induced interpolation for cellular networks.” IEEE Access 7 (2019): 80767-80777.
2. Hebbalaguppe, Ramya, et al. “Telecom Inventory management via object recognition and localisation on Google Street View Images.” 2017 IEEE winter conference on applications of computer vision (WACV). IEEE, 2017.
3. Zhang, Yanyu, and Osama Alshaykh. “5G Utility Pole Planner Using Google Street View and Mask R-CNN.” 2020 IEEE International Conference on Electro Information Technology (EIT). IEEE, 2020.
4. Zhang, Weixing, et al. “Using deep learning to identify utility poles with crossarms and estimate their locations from google street view images.” Sensors 18.8 (2018): 2484.

1. A computer-implemented method, performed by a first node, the method being for handling location of a network node in a geographical area for operation in a communications system, the method comprising:
obtaining first data indicating images of the geographical area over a first time period;
obtaining second data indicating data samples of performance indicators of radio communications, during the first time period, of devices in the geographical area;
determining, by performing a spatio-temporal correlation of the obtained first data and the obtained second data, one or more locations as candidates to place the network node for operation in the communications system, wherein the determining is performed using machine learning or deep learning; and
outputting an indication of the determined one or more locations.

2. The method according to claim 1, wherein the determining of the one or more locations is to meet one or more Key Performance Indicator, KPI, targets.

3. The method according to claim 1, the method further comprising:
processing the obtained first data for subsequent analysis;
extracting a region of interest from the processed first data;
determining, using the extracted first data, an identification of existing network nodes in the extracted region of interest or geographical area;
determining, using the extracted first data, a classification of the existing network nodes in the extracted region of interest or geographical area;
determining, using the extracted first data, a respective first location of the existing network nodes in the extracted region of interest or geographical area;
determining, using the extracted first data, a respective height of the existing network nodes in the extracted region of interest or geographical area;
determining, using the extracted first data, one or more aspects of constructability in the extracted region of interest or geographical area; and
iterating the processing of the obtained first data, the extracting, the determining of the identification, the determining of the classification, the determining of the respective first location, the determining of the respective height, and the determining of the one or more aspects of constructability as new first data are obtained,
wherein the determining of the one or more locations is based on the determined at least one of: identification, classification, respective first location, respective height, and one or more aspects.

4. The method according to claim 3, further comprising at least one of:
determining a respective first accuracy of the determined at least one of: the identification of existing network nodes, the classification of the existing network nodes, the respective first location of existing network nodes, the respective height of the existing network nodes and the one or more aspects of constructability, and wherein the determining of the one or more locations is based on the determined: identification, classification, respective first location, respective height, and one or more aspects only after a respective first accuracy threshold has been achieved, and
outputting a respective first indication of the determined at least one of: identification, classification, respective first location, respective height, and one or more aspects.

5. The method according to claim 3, wherein at least one of: the determining of the classification, the determining of the respective first location, the determining of the respective height, and the determining of the one or more aspects of constructability, is performed using computer vision methods.

6. The method according to claim 1, the method further comprising:
processing the obtained second data for subsequent analysis;
filtering the processed second data based on one or more first criteria for selection for performing the determining of the one or more locations;
determining, using the filtered second data, a respective second location of existing cells serving the geographical area;
determining, using the determined respective second location of the existing cells a respective third location of existing network nodes in the geographical area;
determining, using the determined respective second location of the existing cells and the respective third location of the existing network nodes one or more cell coverage polygons in the geographical area; and
iterating the processing of the obtained second data, the filtering of the processed second data, the determining of the respective second location, the determining of the respective third location and the determining of the one or more cell coverage polygons as new second data are obtained,
wherein the determining of the one or more locations is based on the determined respective second location of the existing cells, the respective third location of the existing network nodes and the determined one or more cell coverage polygons.

7. The method according to claim 6, further comprising at least one of:
determining a respective second accuracy of the determined at least one of: respective second location of the existing cells, respective third location of existing network nodes and one or more cell coverage polygons in the geographical area, and wherein the determining of the one or more locations is based on the determined respective second location of the existing cells, the respective third location of existing network nodes and the determined one or more cell coverage polygons, only after a respective second accuracy threshold has been achieved,
outputting a respective second indication of the determined at least one of: respective second location of the existing cells, respective third location of existing network nodes and one or more cell coverage polygons in the geographical area, and
ranking the one or more locations based on one or more second criteria, and wherein the indication indicates the ranked one or more locations.

8. The method according to claim 3, wherein at least one of:
the determining of the one or more locations is based on one or more attention-based layers in a neural network, and
the determining of the one or more locations is based on a validation layer that aligns the determined respective first location of the existing network nodes with the respective third location of existing network nodes.

9. The method according to claim 1, wherein at least one of:
the images are street-view images, drone images or digital images,
the second data is crowdsourced data,
the communications system is a Fifth Generation, 5G, system, and
the outputting is to a second node operating in the communications system.

10. A first node, for handling location of a network node in a geographical area for operation in a communications system, the first node being configured to:
obtain first data configured to indicate images of the geographical area over a first time period;
obtain second data configured to indicate data samples of performance indicators of radio communications, during the first time period, of devices in the geographical area;
determine, by performing a spatio-temporal correlation of the first data and the second data configured to be obtained, one or more locations as candidates to place the network node for operation in the communications system, wherein the determining is configured to be performed using machine learning or deep learning; and
output an indication of the one or more locations configured to be determined.

11. The first node according to claim 10, wherein the determining of the one or more locations is configured to be to meet one or more Key Performance Indicator, KPI, targets.

12. The first node according to claim 10, the first node being further configured to:
process the first data configured to be obtained for subsequent analysis;
extract a region of interest from the first data configured to be processed;
determine, using the first data configured to be extracted, an identification of existing network nodes in the region of interest configured to be extracted or geographical area;
determine, using the first data configured to be extracted, a classification of the existing network nodes in the region of interest configured to be extracted or geographical area;
determine, using the first data configured to be extracted, a respective first location of the existing network nodes in the region of interest configured to be extracted or geographical area;
determine, using the first data configured to be extracted, a respective height of the existing network nodes in the extracted region of interest or geographical area;
determine, using the first data configured to be extracted, one or more aspects of constructability in the region of interest configured to be extracted or geographical area; and
iterate the processing of the first data configured to be obtained, the extracting, the determining of the identification, the determining of the classification, the determining of the respective first location, the determining of the respective height, and the determining of the one or more aspects of constructability as new first data are obtained,
wherein the determining of the one or more locations is configured to be based on the at least one of: identification, classification, respective first location, respective height, and one or more aspects, configured to be determined.

13. The first node according to claim 12, being further configured to at least one of:
determine a respective first accuracy of the at least one of: the identification of existing network nodes, the classification of the existing network nodes, the respective first location of existing network nodes, the respective height of the existing network nodes and the one or more aspects of constructability configured to be determined, and wherein the determining of the one or more locations is configured to be based on the: identification, classification, respective first location, respective height, and one or more aspects configured to be determined only after a respective first accuracy threshold has been achieved, and
output a respective first indication of the determined at least one of: identification, classification, respective first location, respective height, and one or more aspects.

14. The first node according to claim 12, wherein at least one of: the determining of the classification, the determining of the respective first location, the determining of the respective height, and the determining of the one or more aspects of constructability, is configured to be performed using computer vision methods.

15. The first node according to claim 10, the first node being further configured to:
process the second data configured to be obtained for subsequent analysis;
filter the second data configured to be processed based on one or more first criteria for selection for performing the determining of the one or more locations;
determine, using the filtered second data, a respective second location of existing cells configured to be serving the geographical area;
determine, using the respective second location of the existing cells configured to be determined, a respective third location of existing network nodes in the geographical area;
determine, using the respective second location of the existing cells configured to be determined and the respective third location of the existing network nodes one or more cell coverage polygons in the geographical area; and
iterate the processing of the second data configured to be obtained, the filtering of the second data configured to be processed, the determining of the respective second location, the determining of the respective third location and the determining of the one or more cell coverage polygons as new second data are obtained,
wherein the determining of the one or more locations is configured to be based on the respective second location of the existing cells configured to be determined, the respective third location of the existing network nodes and the one or more cell coverage polygons configured to be determined.

16. The first node according to claim 15, being further configured to at least one of:
determine a respective second accuracy of the at least one of: respective second location of the existing cells, respective third location of existing network nodes and one or more cell coverage polygons in the geographical area configured to be determined, and wherein the determining of the one or more locations is configured to be based on the respective second location of the existing cells configured to be determined, the respective third location of existing network nodes and the one or more cell coverage polygons configured to be determined, only after a respective second accuracy threshold is configured to have been achieved,
output a respective second indication of the at least one of: respective second location of the existing cells, respective third location of existing network nodes and one or more cell coverage polygons in the geographical area configured to be determined, and
rank the one or more locations based on one or more second criteria, and wherein the indication is configured to indicate the one or more locations configured to be ranked.

17. The first node according to claim 12, wherein at least one of:
the determining of the one or more locations is configured to be based on one or more attention-based layers in a neural network, and
the determining of the one or more locations is configured to be based on a validation layer that is configured to align the respective first location of the existing network nodes configured to be determined with the respective third location of existing network nodes.

18. The first node according to claim 10, wherein at least one of:
the images are configured to be street-view images, drone images or digital images,
the second data is configured to be crowdsourced data,
the communications system is configured to be a Fifth Generation, 5G, system, and
the outputting is configured to be to a second node configured to be operating in the communications system.

19. A computer program, comprising instructions which, when executed on at least one processing circuitry, cause the at least one processing circuitry to carry out operations comprising:
obtain first data indicating images of the geographical area over a first time period;
obtain second data indicating data samples of performance indicators of radio communications, during the first time period, of devices in the geographical area;
determine, by performing a spatio-temporal correlation of the obtained first data and the obtained second data, one or more locations as candidates to place the network node for operation in the communications system, wherein the determining is performed using machine learning or deep learning; and
output an indication of the determined one or more locations.

20. A computer-readable storage medium, having stored thereon a computer program, comprising instructions which, when executed on at least one processing circuitry, cause the at least one processing circuitry to carry out operations comprising:
obtain first data indicating images of the geographical area over a first time period;
obtain second data indicating data samples of performance indicators of radio communications, during the first time period, of devices in the geographical area;
determine, by performing a spatio-temporal correlation of the obtained first data and the obtained second data, one or more locations as candidates to place the network node for operation in the communications system, wherein the determining is performed using machine learning or deep learning; and
output an indication of the determined one or more locations.
